(19) United States
(12) Patent Application Publication
(10) Pub. No.: US 2026/0056320 A1
(43) Pub. Date: Feb. 26, 2026

(54) OPTICAL MEASUREMENT SYSTEM AND OPTICAL MEASUREMENT METHOD

(71) Applicant: HAMAMATSU PHOTONICS K.K., Hamamatsu-shi, Shizuoka (JP)

(72) Inventor: Peter SEITZ, Solothurn (CH)

(73) Assignee: HAMAMATSU PHOTONICS K.K., Hamamatsu-shi, Shizuoka (JP)

(21) Appl. No.: 19/104,769

(22) PCT Filed: Nov. 16, 2023
(86) PCT No.: PCT/JP2023/041348

§ 371 Date: Feb. 19, 2025

(30) Foreign Application Priority Data
Nov. 18, 2022 (CH) CH001378/2022

(51) Int. Cl. G01S 17/894; G01S 7/481; G01S 7/4915; G01S 17/86; G06T 7/521; G06T 7/593; H04N 13/243; H04N 13/25; H04N 13/254; H04N 23/667

(52) U.S. Cl. CPC G01S 17/894; G01S 7/4814; G01S 7/4915; G01S 17/86; G06T 7/521; G06T 7/593; H04N 13/243; H04N 13/25; H04N 13/254; H04N 23/667; G06T 2207/10024; G06T 2207/10028

(57) ABSTRACT

An optical measurement system includes a first optical transceiver including a first light source, a first camera, a second camera, and a first beam splitter, and a second optical transceiver including a second light source, a third camera, a fourth camera, and a second beam splitter. The optical measurement system operates in at least one operation mode including a first operation mode. In the first operation mode, the first camera and the third camera are employed to determine a three-dimensional shape of an environment using a triangulation technique, and at least one of the second camera and the fourth camera is employed to determine the three-dimensional shape of the environment using a time-of-flight technique.

### TECHNICAL FIELD

An aspect of the present disclosure relates to optical measurement systems for navigation in a three-dimensional environment, by providing reliable three-dimensional images of this environment.

In particular, an aspect of the present disclosure relates to optical three-dimensional imaging of scenes with extreme dynamic range of the background illumination, ranging from star-lit night to sunlight-flooded daytime.

### BACKGROUND ART

Our world is three-dimensional, and therefore any man-made apparatus that needs to navigate in this world needs to know its location in the three-dimensional environment. For this purpose 3D cameras were invented, exploiting various physical phenomena, including active 3D imaging techniques such as radar, ultrasound or optical time-of-flight imaging, or passive 3D imaging techniques such as triangulation, in particular in the form of stereo vision. In the animal kingdom, most creatures make use of passive triangulation for navigation, often employing two cameras (eyes) for stereo vision, or sometimes using even more than two eyes for multi-camera triangulation.

Optical distance cameras are of particular interest due to the possibility to implement them in compact, economical form with powerful solid-state light sources and image sensors. However, optical distance cameras that are used in uncontrolled outdoor environments are faced with the challenge of extreme variations in background illumination: Full daylight corresponds to an illuminance of about 100,000 lux, while moon-less starlight on a clear sky corresponds to an illuminance of about 0.001 lux. Thus any optical distance camera used for navigation outdoors has to cope with a dynamic range of the background illuminance of at least eight orders of magnitude.

In addition to this problem of extreme dynamic range of background illuminance, the various optical 3D measurement techniques have their proper shortcomings:

In the case of passive triangulation, a sufficient amount of scene brightness is required, so that features in the scene become visible and exploitable for stereo vision by the employed image sensors. This problem can be solved by illuminating the scene with artificial light for all conditions where the natural background illumination is insufficient. A severe shortcoming of triangulation is its reliance on distinctive features on the various objects, which are essential for determining the distance to each feature. On a blank wall, a white cover, a plain surface, no feature is visible, and thus triangulation does not work. Such unstructured surfaces are common in man-made environments, and for this reason, triangulation 3D imaging is unsuitable for all parts of a scene in which such plain surfaces are present. In some instances, where the background illumination is not too high, this problem can be overcome by providing structured illumination of the scene, thus creating the required features on the surface of plain objects.

In the case of optical time-of-flight (TOF) 3D measurement techniques, it is necessary to determine at each pixel site the time of arrival of optical pulses or the phase delay in a modulated waveform emitted by the distance camera's light source. These measurements can reliably be made provided that the reflecting surface does not have excessive height variations. Unfortunately, this condition is often violated at the boundary of objects, where the object reflects part of the modulated light, and the background reflects another part of the modulated light, resulting in erroneous phase-delay or time-of-arrival measurements. These so-called multi-path errors can also occur at surfaces that are partially reflective, so that more than one object, and each at its own distance to the camera, contribute to the total reflectance signal. Such multi-path errors can be eliminated by making use of special measurement technique such as FMCW (Frequency Modulated Continuous Wave) lidar. However, this necessitates the acquisition of a large amount of additional back-reflectance information, adding significant complexity to the imaging and to the data processing tasks.

### SUMMARY OF INVENTION

### Technical Problem

An objective of an aspect of the present disclosure is to address the aforementioned problems of extreme dynamic range in background illuminance, triangulation's inability to determine distance data to unstructured surfaces, and TOF techniques' erroneous distance measures due to multi-path effects, by providing an optical distance camera whose components jointly contribute to the solution of all of the aforementioned problems, depending on the level of background illuminance.

### Solution to Problem

The optical distance camera according to an aspect of the present disclosure consists of two or more transceiver modules. Each transceiver consists of one light source whose intensity can be temporally modulated, a beam splitter directing the reflected light into a first and a second camera, and an electronic control system for the acquisition and the processing of the signals from the first and the second camera. The first camera acquires intensity or color images of the scene in view, in the wavelength range of the background light and the light source. The second camera consists of pixels that are each capable of sensing and demodulating incident modulated light, back-reflected from the objects in the scene.

Under high illuminance conditions, such as in full daylight, the first cameras of the two or more transceiver modules are employed to determine the three-dimensional shape of the environment using known triangulation techniques. Under moderate illuminance conditions, both the triangulation and the time-of-flight three-dimensional cameras of the transceivers are employed. Under low illuminance conditions, such as during night, the second camera of each transceiver is employed to determine the three-dimensional shape of the environment using known time-of-flight techniques. Under conditions with wide illumination differences, such as driving a vehicle out of a tunnel into full daylight, the first cameras of the transceiver modules are employed to determine the three-dimensional shape of the brightly lit parts in the scene using triangulation, and the second cameras are employed to determine the three-dimensional shape of weakly lit parts of in the scene using time-of-flight techniques.

This combination of triangulation and TOF technique for distance measurement overcomes also triangulation's problem with unstructured surfaces and TOF techniques' problem with multi-path imaging: In those parts of the scene, where unstructured surfaces are present, the results of the TOF imaging cameras are employed, and at the border of objects, TOF results are discarded and triangulation results are employed, which work best for high-contrast situations often occurring at object boundaries.

In this way, the DC part of the modulated light source is employed for triangulation, while the AC part of the modulated light source is demodulated and employed for one of the known TOF imaging techniques.

An optical measurement system according to an aspect of the present disclosure includes: a first optical transceiver including a first light source that emits light modulated at frequencies exceeding 100 kHz, a first camera that acquires intensity or color images, a second camera capable of sensing and demodulating the light emitted from the first light source and reflected by an object, and a first beam splitter that separates and directs the reflected light to the first camera and the second camera; and a second optical transceiver including a second light source that emits light modulated at frequencies exceeding 100 kHz, a third camera that acquires intensity or color images, a fourth camera capable of sensing and demodulating the modulated light emitted from the second light source and reflected by the object, and a second beam splitter that separates and directs the reflected light to the third camera and the fourth camera. The optical measurement system operates in at least one operation mode including a first operation mode, and in the first operation mode, the first camera and the third camera are employed to determine a three-dimensional shape of an environment using a triangulation technique, and at least one of the second camera and the fourth camera is employed to determine the three-dimensional shape of the environment using a time-of-flight technique.

The at least one operation mode may include a second operation mode, and in the second operation mode, the first camera and the third camera may be employed to determine the three-dimensional shape of the environment using the triangulation technique, and the second camera and the fourth camera may not be employed to determine the three-dimensional shape of the environment.

The at least one operation mode may include a third operation mode, and in the third operation mode, the first camera and the third camera may not be employed to determine the three-dimensional shape of the environment, and at least one of the second camera and the fourth camera may be employed to determine the three-dimensional shape of the environment using the time-of-flight technique.

In at least one of the at least one operation mode, both of the first light source and the second light source may emit light towards the object.

When using the time-of-flight technique, both of the second camera and the fourth camera may be employed to determine the three-dimensional shape of the environment using the time-of-flight technique.

Under a first condition (moderate illuminance condition), the optical measurement system may operate in the first operation mode, and under a second condition (high illuminance condition) in which background illuminance is higher than background illuminance in the first condition, the optical measurement system may operate in the second operation mode.

Under a first condition (moderate illuminance condition), the optical measurement system may operate in the first operation mode and under a third condition (low illuminance condition) in which background illuminance is lower than background illuminance in the first condition, the optical measurement system may operate in the third operation mode.

In the first operation mode (under low or no illuminance condition), the first camera and the third camera may be employed to determine the three-dimensional shape of a first part in the environment using the triangulation technique, and the at least one of the second camera and the fourth camera may be employed to determine the three-dimensional shape of a second part of the environment using the time-of-flight technique, the second part being weakly lit than the first part. That is, the first part is a brightly lit part and the second part is a weakly lit part.

In the first operation mode, a DC part of the modulated light may be employed for the triangulation technique, while an AC part of the modulated light may be demodulated and employed for the time-of-flight technique.

Each of the first light source and the second light source may include lasers with wavelength of red, green, and blue, respectively. Alternatively, each of the first light source and the second light source may include a white LED.

Each of the first camera and the third camera may include a color filter, an imaging lens, and a black and white or color image sensor

Each of the second camera and the fourth camera may include a color filter, an imaging lens, and a demodulation image sensor.

An optical measurement method according to an aspect of the present disclosure uses an optical measurement system. The optical measurement system includes: a first optical transceiver including a first light source that emits light modulated at frequencies exceeding 100 kHz, a first camera that acquires intensity or color images, a second camera capable of sensing and demodulating the light emitted from the first light source and reflected by an object, and a first beam splitter that separates and directs the reflected light to the first camera and the second camera; and a second optical transceiver including a second light source that emits light modulated at frequencies exceeding 100 kHz, a third camera that acquires intensity or color images, a fourth camera capable of sensing and demodulating the modulated light emitted from the second light source and reflected by the object, and a second beam splitter that separates and directs the reflected light to the third camera and the fourth camera. The optical measurement method includes causing the optical measurement system to operate in a first operation mode, wherein in the first operation mode, the first camera and the third camera are employed to determine a three-dimensional shape of an environment using a triangulation technique, and at least one of the second camera and the fourth camera is employed to determine the three-dimensional shape of the environment using a time-of-flight technique.

Only either one of the first light source and the second light source may be provided. Only either one of the second camera and the fourth camera may be provided. That is, an optical measurement system according to another aspect of the present disclosure includes: a first optical transceiver including a light source that emits light modulated at frequencies exceeding 100 kHz, a first camera that acquires intensity or color images, a second camera capable of sensing and demodulating the light emitted from the first light source and reflected by an object, and a first beam splitter that separates and directs the reflected light to the first camera and the second camera; and a second optical transceiver including a third camera that acquires intensity or color images. The optical measurement system operates in at least one operation mode including a first operation mode, and in the first operation mode, the first camera and the third camera are employed to determine a three-dimensional shape of an environment using a triangulation technique, and the second camera is employed to determine the three-dimensional shape of the environment using a time-of-flight technique.

### BRIEF DESCRIPTION OF DRAWINGS

An aspect of the present disclosure will be better understood and objects other than those set forth above will become apparent when consideration is given to the following detailed description thereof. Such description makes reference to the annexed drawing, wherein:

FIG. 1 shows the schematic architecture of one optical transceiver, consisting of a modulated light source, a first imaging system used for triangulation, and a second imaging system used for TOF demodulation, all under the control of an electronic processing unit.

FIG. 2 shows one embodiment of the optical distance camera, consisting of two transceivers separated by the triangulation base D.

### DESCRIPTION OF EMBODIMENTS

It is a principal object of an aspect of the present disclosure to provide an optical distance camera offering such high dynamic range operation that the distance camera can be employed in all situations that are uncontrolled regarding background illuminance.

It is a further object of an aspect of the present disclosure to provide an optical distance camera that can generate reliable distance images when used outside, covering the wide natural illuminance range from full daylight to star-lit night.

It is another object of an aspect of the present disclosure to provide an optical distance camera that overcomes the main problems of stereo vision techniques, the impossibility to determine distances to objects with unstructured surfaces, and the main problems of time-of-flight techniques, saturation of time-of-arrival image sensors and incorrect distance readings due to multi-path reflection signals.

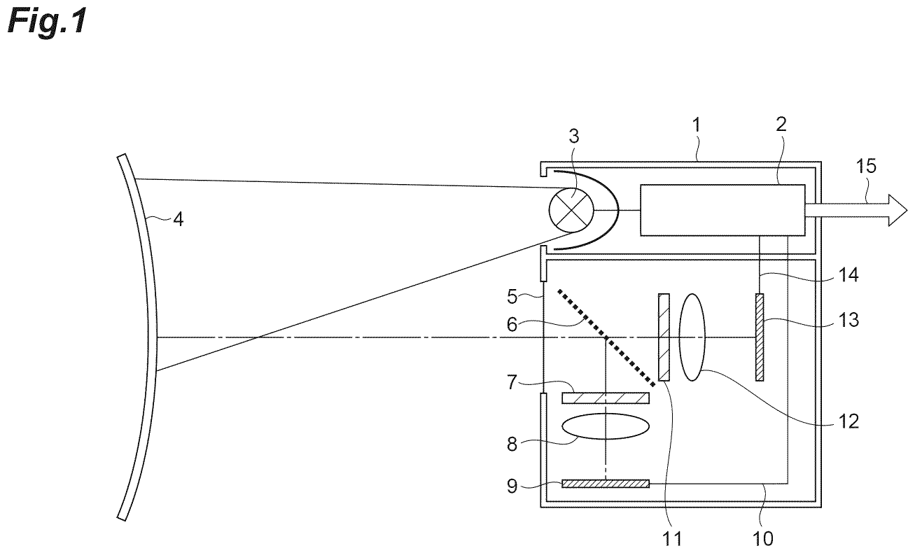

The basic element of the optical distance camera according to this example is the transceiver schematically illustrated in FIG. 1. The transceiver is contained in transceiver casing 1. Central processing unit 2 controls all sub-units contained in the transceiver. Processing unit 2 modulates solid-state light source 3, emitting light at sufficiently high modulation frequencies, typically exceeding 100 kHz, employed for any of the known TOF distance measurement techniques. The modulated light is reflected by object surface 4, entering the transceiver through front window 5. Beam splitter 6 separates the incoming, back-reflected light into two portions, directing the incident light into either of two camera sub-systems. It is not necessary that the two parts are of equal proportion. Rather it may be preferrable that the camera sub-system used for triangulation obtains proportionally less light, while the TOF camera sub-system obtains proportionally more light.

A first camera, used for triangulation distance imaging, consists of color filter 7, imaging lens 8, and high-resolution black-and-white or color image sensor 9. Central processing unit 2 controls the image acquisition process of image sensor 9 through electronic interface 10, synchronizing it with the other components of the distance camera system according to this example. Color filter 7 is used to transmit only light with desired wavelengths from object surface 4 to image sensor 9. Infrared wavelengths may not be desirable because of their large penetration depth into image sensor 9, causing blurred images and reducing the effectiveness of feature-extracting triangulation algorithms. Shorter wavelengths, reaching into the ultraviolet, may not be desirable because of damage that the high-energy wavelength light may cause in image sensor 9.

A second camera, used for TOF-based distance imaging, consists of color filter 11, imaging lens 12 and demodulation image sensor 13. Central processing unit 2 controls the image acquisition process of image sensor 13 through electronic interface 14, synchronizing it with the other components of the distance camera system, in particular synchronizing the demodulation function of image sensor 13 to the modulation of light source 3. Color filter 11 is used to transmit only light with desired wavelengths from object surface 4 to demodulation image sensor 13. In particular, color filter 11 is used to reject background light that is not originating from modulated light source 3 but rather from natural or artificial light sources in the scene. This is often possible because modulated light source 3 is a solid-state device whose wavelength spectrum exhibits peaks which can be preferentially passed to demodulation image sensor 13. As an example, consider modulated light source 3 consisting of lasers with three different monochromatic wavelengths red, green and blue, in such a proportion that the emitted, modulated light appears white to the human eye. In this case it is advantageous that color filter 11 rejects all wavelengths except one or several of the three monochromatic wavelength peaks of the lasers. Alternatively, consider a modulated light source consisting of a white LED. The white appearance of the LED is achieved by coating a blue LED with a phosphor layer such that much of the blue light is converted into light of longer wavelengths, giving the overall color impression of “white” to the human eye. Nevertheless, the wavelength spectrum of such a white LED shows a peak in the blue. In this case it is advantageous that color filter 11 rejects all wavelengths except the blue peak in the white LED's wavelength spectrum.

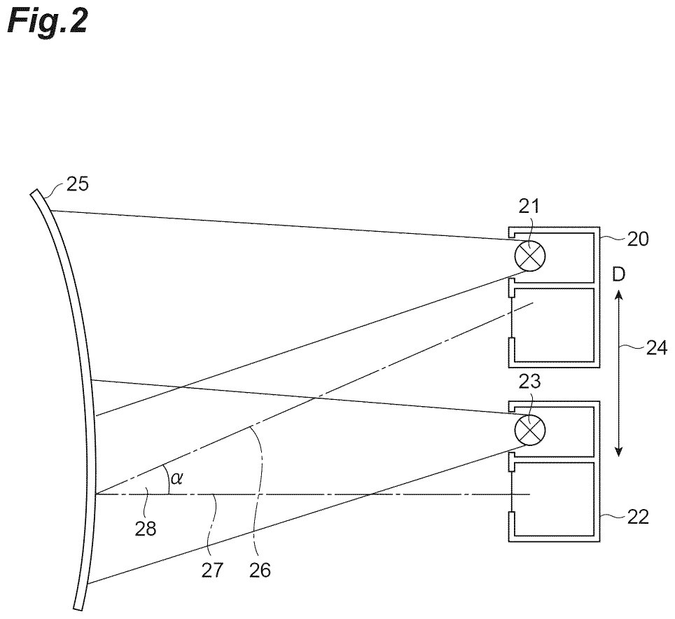

The distance camera according to this example consists of two or more transceivers illustrated in FIG. 1. The simplest configuration, consisting of two transceivers, is illustrated in FIG. 2. First transceiver 20 with modulated light source 21 is laterally displaced by triangulation base distance 24 from second transceiver 22 with modulated light source 23.

Modulated light from light sources 21 and 23 is emitted towards object surface 25, from which it is back-reflected into the camera sub-systems of transceivers 20 and 22. Light emitted from one point on object surface 25 will travel along direction 26 into first transceiver 20, and along direction 27 into second transceiver 22. Angle 28 between directions 26 and 27 is known as triangulation angle α.

That is, in this example, the system includes the first transceiver 20 and the second transceiver 22. As described above referring to FIG. 1, each of the first transceiver 20 and the second transceiver 22 may be configured as shown in FIG. 1. The first transceiver 20 includes the light source 3 (first light source), the camera (first camera) consisting of the color filter 7, imaging lens 8, and image sensor 9, the camera (second camera) consisting of the color filter 11, imaging lens 12, and demodulation image sensor 13, and the beam splitter 6 (first beam splitter). The second transceiver 22 includes the light source 3 (second light source), the camera (third camera) consisting of the color filter 7, imaging lens 8, and image sensor 9, the camera (fourth camera) consisting of the color filter 11, imaging lens 12, and demodulation image sensor 13, and the beam splitter 6 (second beam splitter).

In the case that more than two transceivers are employed for implementing the distance camera, each pair of transceivers can be considered a stereo pair as illustrated in FIG. 2.

The distance camera according to this example achieves its large dynamic range regarding background illuminance levels by its three modes of operation:

(1) In the case that background illuminance level is so high that demodulation image sensor 13 saturates and cannot measure phase delays or time-of-arrival of modulated light reliably, the multitude of transceivers with their mutual triangulation angles α is employed to create 3D images of the environment according to known methods of triangulation. This case usually occurs when the distance camera is operated outdoors in full daylight.

(2) In the case that background illuminance is moderate, i.e. demodulation image sensor 13 does not saturate, both camera sub-systems of each transceiver can be employed for the acquisition of 3D images. The multitude of transceivers with their mutual triangulation angles α is employed to create 3D images of the environment according to known methods of triangulation and stereo vision. Each TOF camera of the individual transceivers is employed to create 3D images of the environment according to known methods of time-of-flight imaging.

Several transceivers may be in operation simultaneously, either located on the same apparatus or in the field of view of this apparatus. For this reason, TOF imaging techniques must be employed allowing the simultaneous operation of several TOF cameras with minimum mutual interference, as described for example by B. Büttgen et al. in “Pseudonoise Optical Modulation for Real-Time 3-D Imaging With Minimum Interference”, IEEE Transactions on Circuits and Systems 1, Vol. 54, No. 10, October 2007. In this way, the DC part of light source 3 is employed to brighten parts of the scene where little natural light is available, thus improving the performance of the triangulation subsystems, and the AC part of light source 3 is employed for the implementation of the modulation/demodulation scheme required for the TOF subsystem. This case of moderate background illuminance, where both distance camera sub-systems operate concurrently, allows the fusion of distance information from both distance camera sub-systems, overcoming the shortcomings of each particular 3D imagery technique: Unstructured object surfaces illuminated with unstructured natural or artificial light do not provide local features, as required for triangulation and stereo vision techniques. As a consequence, in those parts of the scene where no discernible features are present, only distance information provided by the TOF camera sub-system is employed. Conversely, most TOF imaging techniques suffer from multi-path problems, where each TOF pixel receives modulated light from various distances, thus violating the mathematical assumptions for those TOF 3D signal extraction methods. Multi-path reflection often occurs at the boundary of objects; these boundaries provide regions of strong features, where triangulation techniques function particularly well. For this reason, in those parts of the scene where object boundaries are present, only distance information provided by the triangulation camera sub-system is employed

(3) In the case that there is so little back-reflected light from the target objects in the scene so that triangulation sensor 9 cannot produce sufficient signal-to-noise ratios for reliable triangulation, only the TOF cameras in the various transceivers are employed. A typical situation where this occurs is night-time operation of the distance camera with the task of imaging objects that are so far away that light source 3 does not provide sufficient illumination for triangulation sensor 9. It is possible that in this case there are additional light sources in the field of view of the distance camera, such as the headlights of an oncoming car, street lights, or light sources in or on buildings. These light sources are of limited geometrical extent and they provide image data with high local contrast. Thus, they can be employed by the triangulation sub-system for reliable distance imaging in all parts of the scene where such additional light sources are present.

That is, the system can operate in a first operation mode, a second operation, and third operation mode. The central processing unit 2 (controller) may operate the system in the three operation modes. In other words, the controller may switch the operation mode among the three operation modes. As described above, the operation mode may be switched based on the detection results of the image sensor 9 (first and third cameras) and the image sensor 13 (second and fourth cameras). The first operation mode corresponds to the case (2) above. In the first operation mode, the first camera and the third camera are employed to determine the three-dimensional shape of the environment using the triangulation technique, and the second camera and the fourth camera are employed to determine the three-dimensional shape of the environment using the TOF technique. The second operation mode corresponds to the case (1) above. In the second operation mode, the first camera and the third camera are employed to determine the three-dimensional shape of the environment using the triangulation technique, and the second camera and the fourth camera are not employed to determine the three-dimensional shape of the environment. The third operation mode corresponds to the case (3) above. In the third operation mode, the first camera and the third camera are not employed to determine the three-dimensional shape of the environment, and the second camera and the fourth camera are employed to determine the three-dimensional shape of the environment using the TOF technique. The system operates in the first operation mode under the first condition where the background illuminance is moderate. The system operates in the second operation mode under the second condition where the background illuminance is higher than that in the first condition. The system operates in the third operation mode under the third condition where the background illuminance is lower than that in the first condition. In all the three operation modes, both of the light sources 3 of the first and second transceivers emit light towards the object surface 4.

In summary, three operational regimes of the distance camera according to this example exist, and the information from the two camera sub-systems of each transceiver is combined in different ways:

(1) In the case of high background illuminance, only 3D imagery from the triangulation sub-system is employed.

(2) In the case of moderate background illuminance, both triangulation 3D imagery and TOF 3D imagery are employed, making exclusive use of one modality in image areas in which one of the 3D imaging techniques has weaknesses: In parts of the scene with weak or no features, TOF 3D data are preferably used, and in parts of the scene containing object boundaries, triangulation data are preferably used.

(3) In the case of low or no background illuminance, TOF 3D data are used predominantly, except in parts of the scene containing light sources, whose distances are preferably determined with triangulation.

Although an example of the present disclosure has been described above, the present disclosure is not limited to the above-described example. The system may operate in the first operation mode only. The system may not operate in the second operation or the third operation mode. In the first operation mode, at least one of the second camera and the fourth camera may be employed to determine the three-dimensional shape of the environment using the TOF technique, and either one of the second camera and the fourth camera may not be employed to determine the three-dimensional shape of the environment.

An aspect of the present disclosure is a device and method for the reliable measurement of distance imagery in applications with high dynamic range of the background illumination, consisting of two or more optical transceivers characterized in that each transceiver contains a light source whose intensity can be temporally modulated at high frequencies exceeding 100 kHz, a beam splitter allowing two camera systems to view the scene simultaneously, a first camera acquiring intensity or color images, and a second camera capable of sensing and demodulating the back-reflected light originating from the modulated light source, such that under high illuminance conditions, triangulation 3D imaging methods are employed, under moderate illuminance conditions, both triangulation and time-of-flight 3D imaging methods are employed, and under low or no illuminance conditions, time-of-flight 3D imaging methods are employed, with local use of triangulation 3D imaging methods for light sources in the field of view.

An aspect of the present disclosure is an optical distance camera with extremely high dynamic range regarding background illumination levels consists of two or more transceiver modules. Each transceiver consists of one light source whose intensity can be temporally modulated, a beam splitter directing the reflected light into a first and a second camera, and an electronic control system for the acquisition and the processing of the signals from the first and the second camera. The first camera acquires intensity or color images of the scene in view, in the wavelength range of the natural background light and the light source. The second camera's image sensor contains pixels that are each capable of sensing and demodulating incident modulated light, back-reflected from the objects in the scene.

Under high illuminance conditions, such as in full daylight, the first cameras of the two or more transceiver modules are employed to determine the three-dimensional shape of the environment using known triangulation techniques. Under moderate illuminance conditions, both the triangulation and the time-of-flight three-dimensional cameras of the transceivers are employed. Under low illuminance conditions, such as during night, the second camera of each transceiver is employed to determine the three-dimensional shape of the environment using known time-of-flight techniques. Under conditions with wide illumination differences, such as driving a vehicle out of a tunnel into full daylight, the first cameras of the transceiver modules are employed to determine the three-dimensional shape of the brightly lit parts in the scene using triangulation, the second cameras are employed to determine the three-dimensional shape of weakly lit parts of the scene using time-of-flight techniques.

1. An optical measurement system comprising:
a first optical transceiver including a first light source that emits light modulated at frequencies exceeding 100 kHz, a first camera that acquires intensity or color images, a second camera capable of sensing and demodulating the light emitted from the first light source and reflected by an object, and a first beam splitter that separates and directs the reflected light to the first camera and the second camera; and
a second optical transceiver including a second light source that emits light modulated at frequencies exceeding 100 kHz, a third camera that acquires intensity or color images, a fourth camera capable of sensing and demodulating the modulated light emitted from the second light source and reflected by the object, and a second beam splitter that separates and directs the reflected light to the third camera and the fourth camera,
wherein the optical measurement system operates in at least one operation mode including a first operation mode, and in the first operation mode, the first camera and the third camera are employed to determine a three-dimensional shape of an environment using a triangulation technique, and at least one of the second camera and the fourth camera is employed to determine the three-dimensional shape of the environment using a time-of-flight technique.

2. An optical measurement system according to claim 1,
wherein the at least one operation mode includes a second operation mode, and in the second operation mode, the first camera and the third camera are employed to determine the three-dimensional shape of the environment using the triangulation technique, and the second camera and the fourth camera are not employed to determine the three-dimensional shape of the environment.

3. An optical measurement system according to claim 1,
wherein the at least one operation mode includes a third operation mode, and in the third operation mode, the first camera and the third camera are not employed to determine the three-dimensional shape of the environment, and at least one of the second camera and the fourth camera is employed to determine the three-dimensional shape of the environment using the time-of-flight technique.

4. An optical measurement system according to claim 1,
wherein in at least one of the at least one operation mode, both of the first light source and the second light source emit light towards the object.

5. An optical measurement system according to claim 1,
wherein when using the time-of-flight technique, both of the second camera and the fourth camera are employed to determine the three-dimensional shape of the environment using the time-of-flight technique.

6. An optical measurement system according to claim 2,
under a first condition, the optical measurement system operates in the first operation mode, and under a second condition in which background illuminance is higher than background illuminance in the first condition, the optical measurement system operates in the second operation mode.

7. An optical measurement system according to claim 3,
under a first condition, the optical measurement system operates in the first operation mode and under a third condition in which background illuminance is lower than background illuminance in the first condition, the optical measurement system operates in the third operation mode.

8. An optical measurement system according to claim 1,
wherein in the first operation mode, the first camera and the third camera are employed to determine the three-dimensional shape of a first part in the environment using the triangulation technique, and the at least one of the second camera and the fourth camera is employed to determine the three-dimensional shape of a second part of the environment using the time-of-flight technique, the second part being weakly lit than the first part.

9. An optical measurement system according to claim 1,
wherein in the first operation mode, a DC part of the modulated light is employed for the triangulation technique, while an AC part of the modulated light is demodulated and employed for the time-of-flight technique.

10. An optical measurement system according to claim 1,
wherein each of the first light source and the second light source includes lasers with wavelength of red, green, and blue, respectively.

11. An optical measurement system according to claim 1,
wherein each of the first light source and the second light source includes a white LED.

12. An optical measurement system according to claim 1,
wherein each of the first camera and the third camera includes a color filter, an imaging lens, and a black and white or color image sensor.

13. An optical measurement system according to claim 1,
wherein each of the second camera and the fourth camera includes a color filter, an imaging lens, and a demodulation image sensor.

14. An optical measurement method using an optical measurement system,
the optical measurement system comprising:
a first optical transceiver including a first light source that emits light modulated at frequencies exceeding 100 kHz, a first camera that acquires intensity or color images, a second camera capable of sensing and demodulating the light emitted from the first light source and reflected by an object, and a first beam splitter that separates and directs the reflected light to the first camera and the second camera; and
a second optical transceiver including a second light source that emits light modulated at frequencies exceeding 100 kHz, a third camera that acquires intensity or color images, a fourth camera capable of sensing and demodulating the modulated light emitted from the second light source and reflected by the object, and a second beam splitter that separates and directs the reflected light to the third camera and the fourth camera,
the optical measurement method comprising causing the optical measurement system to operate in a first operation mode, wherein in the first operation mode, the first camera and the third camera are employed to determine a three-dimensional shape of an environment using a triangulation technique, and at least one of the second camera and the fourth camera is employed to determine the three-dimensional shape of the environment using a time-of-flight technique.
